(19) United States
(12) Patent Application Publication
(10) Pub. No.: US 2012/0026986 A1
(43) Pub. Date: Feb. 2, 2012

(54) Downlink frequency selective scheduling based on channel quality feedback

(75) Inventor: Shweta Jaikrishna Dass, Bangalore (IN)

(73) Assignee: Continuous Computing India Private Ltd., Bangalore (IN)

(21) Appl. No.: 12/846,362

(22) Filed: Jul. 29, 2010

(51) Int. Cl. H04J 3/00

(52) U.S. Cl. 370/336

(57) ABSTRACT

A method for downlink frequency selective scheduling in LTE MAC based on channel quality feedback is disclosed. Existing methods for resource allocation have no means for efficient utilization of the resources and allocation of the available downlink bandwidth to the UE with low computation overhead. These methods do not ensure that the UEs that possess channel quality feedbacks are allocated their best sub-bands for transmission in time and compute efficient manner. The proposed method employs CQI based feedback from the UEs for allocation of the downlink bandwidth. The method defines a threshold value for the CQI and UEs that have sub-bands with CQI lesser than the defined threshold value will not be allocated resources in the corresponding sub-band.

### FIELD OF INVENTION

This invention relates to Long Term Evolution (LTE) Medium Access Control (MAC), and more particularly to downlink frequency selective scheduling in LTE MAC.

### BACKGROUND OF INVENTION

Communications systems employ different schedulers for allocation of resources in selective downlink frequency bands. In these systems, different approaches are used in an attempt to allocate the best sub-bands to User Equipments (UEs) in order to achieve optimal bandwidth utilization and higher cell throughput.

A report based allocation scheme enormously reduces the required feedback capacity demand as compared to the direct approach of allocating resources in selective downlink frequency bands. In the report based allocation scheme, the frequency response is reported in subsequent bands of the frequency. The subsequent bands may be further refined in the process. After a pre-defined number of time slots, outdated bands are updated depending on the reported mobility class of the users. The report based allocation scheme solves weighted sum rate maximization problems for given rate requirements by using an algorithm which employs a weight matching strategy stemming from a Lagrangian approach. However, the report based allocation scheme has high computational complexity.

In a joint allocation scheme, Resource Blocks (RB's) and UE are jointly assigned resources. The resources are jointly assigned so as to maximize the sum of bit rates assigned to all users. The joint allocation scheme has higher computational and time complexity as compared to the direct approach of allocating resources in selective downlink frequency bands. In addition, the joint allocation scheme is not suitable for the 1 ms scheduling period of LTE and also leads to joint multi user optimization problems.

In another approach, OFDMA communication systems may engage in Frequency Diverse Scheduling (FDS) or narrowband scheduling to maximize bandwidth usage, herein referred to as the narrowband allocation scheme. In the narrowband allocation scheme, there are two ways of performing Channel Quality Indicator (CQI) reporting. In one way called non-frequency selective CQI reporting, user equipment (UE) is simply told which sub-band to report on, and the UE reports on the CQI of that sub-band and is scheduled on that sub-band. In another way, called frequency selective CQI reporting, a UE is instructed to measure a list of sub-bands and to report on the sub-bands with the best signal strength. Currently, frequency selective CQI reporting is not used in broadcast or multicast communication sessions (point-to-multipoint). In wideband CQI reporting, wherein a UE reports an average CQI for an entire bandwidth, there is no assurance that a sub-band or sub-bands selected for the broadcast or multicast session will provide acceptable service to all participating UEs.

### SUMMARY

In view of the foregoing, an embodiment herein provides a system for downlink frequency division selective scheduling in a communication network, the system adapted for configuring transmission by assigning a threshold value for feedback reports (which may be a Channel Quality Indicator (CQI) report) of sub-bands; assigning up to maximum downlink bandwidth per User Equipment (UE) to a plurality of UEs; handling the feedback reports by checking validity of the feedback reports; updating the feedback reports; sorting the feedback reports in descending order of their feedback values; computing average deviation of the feedback reports from average value; scheduling a plurality of UEs for transmission during Transmission Time Interval (TTI) by selecting plurality of UEs for resource allocation based on the feedback reports; sorting the UEs for allocation of resource based on their computed average deviation; and allocating resources to the UEs until certain pre-defined limits (which are maximum downlink bandwidth per UE is satisfied; bytes to be allocated for the UEs is exhausted; requirement of resource blocks of the UE is less than half of the size of the available sub-band) are satisfied. The system is adapted for defining the threshold value for feedback reports such that sub-bands having feedback values below the threshold value are not selected for scheduling. The system is adapted for validating the feedback report by checking if the report is the latest report received from the UEs. The system is adapted for updating the feedback report by replacing an available report with the latest report received from the UEs. The system is adapted for dividing the available downlink bandwidth into sub-bands of resource block group (RBG) size. The system is adapted for computing deviation of the feedback report from the average sub-band report value for each sub-band. The system is adapted for computing average deviation of the feedback reports for each UE. The system is adapted for sorting the UEs in descending order of computed average deviation during the TTI.

In another embodiment, a Channel Quality Indicator (CQI) handler module for downlink frequency selective scheduling in a communication network is disclosed, the CQI handler is adapted for performing action that includes at least one of: updating feedback reports received from plurality of UE; sorting the feedback reports of the UE based on feedback values; and computing average deviation of the feedback reports from average report value. The CQI handler module is adapted to manage both wide-band and sub-band feedback reports received from the UEs. The CQI handler module is adapted to sort the feedback reports in descending order of their values.

In another embodiment, a User Equipment (UE) selector module for downlink frequency selective scheduling in a communication network, is adapted for determining scheduling priority of plurality of User Equipments (UE) based on certain factors; and sending a list of UEs to a resource allocator for allocation of bandwidth. The UE selector module is adapted for scheduling priority on factors that include at least one of Quality of Service (QOS) requirements of the service; downlink channel conditions; total power constraints; and total available downlink bandwidth.

In another embodiment, a resource allocator module for downlink frequency selective scheduling in a communication network is adapted for re-arranging received list of UE in descending order of their computed average deviation; allocation of best available sub-bands until pre-defined constraints are satisfied; and determining the modulation and coding scheme based on the feedback report values of UEs. The resource allocator module is adapted for allocation of bandwidth based on constraints that include at least one of: maximum downlink bandwidth per UE is satisfied; bytes to be allocated for the UEs are exhausted or requirement of resource blocks of the UE is less than half the size of available sub-band. The resource allocator module is adapted for sending allocation report of the UEs to a UE selector module.

Further, disclosed is a method for downlink frequency division selective scheduling in a communication network, the method comprising steps of configuring transmission by assigning a threshold value for feedback reports (which may be a Channel Quality Indicator (CQI) report) of sub-bands; assigning maximum downlink bandwidth per User Equipment (UE) to a plurality of UEs; handling the feedback reports by checking validity of the feedback reports; updating the feedback reports; sorting the feedback reports in descending order of their feedback values; and computing average deviation for each UE of the feedback reports from average report value for the UE; scheduling a plurality of UEs for transmission during Transmission Time Interval (TTI) by selecting plurality of UEs for resource allocation based on the feedback reports; sorting the UEs in descending order of computed average deviation during the TTI for allocation of resource based on their feedback reports; and allocating resources to the UEs until pre-defined limits are satisfied. The threshold value for feedback reports is defined such that sub-bands having feedback values below the threshold value are not selected for scheduling. The validation of the report is performed by checking the report is the latest report received from UEs. The updation is performed by replacing an available report with the latest report received from the UEs. The available downlink bandwidth is divided into sub-bands of size of resource block group (RBG). The scheduling priority of the UEs is determined using a UE selector. The modulation and coding schemes are determined based on the CQI values of the UEs.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF FIGURES

This invention is illustrated in the accompanying drawings, throughout which like reference letters indicate corresponding parts in the various figures. The embodiments herein will be better understood from the following description with reference to the drawings, in which:

FIG. 1 depicts the different modules in DLFS architecture, according to embodiments as disclosed herein;

FIG. 2 is a flow chart depicting the DLFS initialization, according to embodiments as disclosed herein;

FIG. 3 is a flow chart depicting the calculation of the CQI values, according to embodiments as disclosed herein; and

FIGS. 4A and 4B are flowcharts depicting the DLFS transmission process, according to embodiments as disclosed herein.

### DETAILED DESCRIPTION OF INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

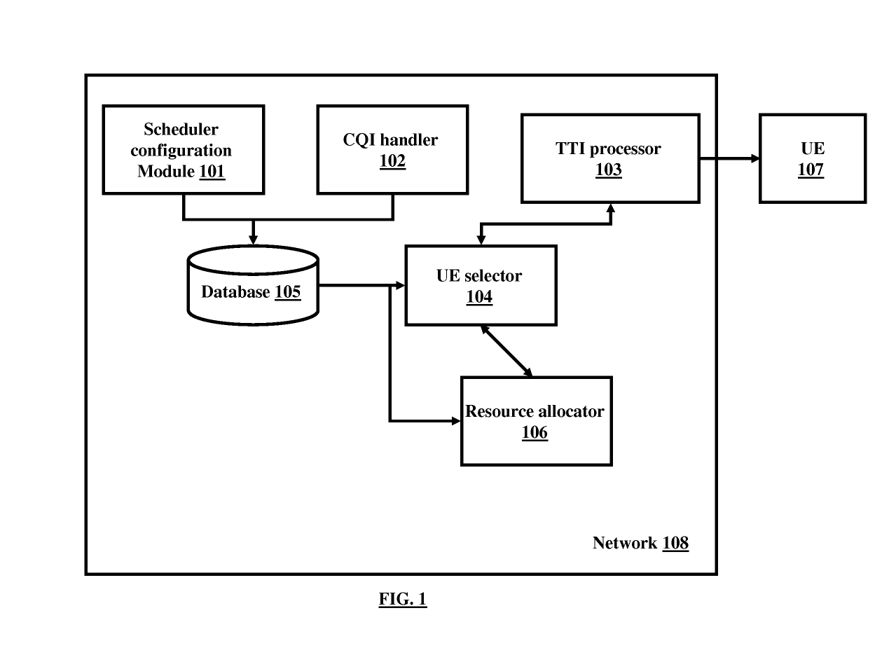

The embodiments herein achieve efficient downlink bandwidth utilization by optimally allocating user equipments in the best sub-bands in downlink frequency bands. Referring now to the drawings, and more particularly to FIGS. 1 through 4, where similar reference characters denote corresponding features consistently throughout the figures, there are shown preferred embodiments.

Systems and methods for efficient allocation of the downlink bandwidth to User Equipments (UEs) are disclosed herein. In a preferred embodiment herein, a method employs techniques for allocation of bandwidth to UEs for ensuring that UEs are allocated their respective best sub-bands based on the priority of the UEs. The method employs feedback techniques for selection of the sub-bands for the UE. The feedback technique may be based on sending of feedback reports. In an embodiment, the feedback report may be a Channel Quality Indicator (CQI) report. In an embodiment, the method may employ an algorithm for performing the entire allocation. The available downlink bandwidth in divided into sub-bands of resource block group size. The CQI values for the sub-bands for each UE are determined, and deviation of the CQI values from the average CQI is computed. The UE's sub-bands having CQI value less than the threshold value will not be chosen for bandwidth allocation. Further, depending on the average deviation of the CQI value from the average of the sub-band CQI values of the UE, the Transmission Time Interval (TTI) module allocates bandwidth to that particular UE. The method ensures that the most deserving UE is served first.

FIG. 1 depicts the different modules in DLFS architecture, according to embodiments as disclosed herein. The architecture involves different modules such as a scheduler configuration module 101, a CQI handler 102, a TTI processor 103, user equipment selector 104, at least one database 105, a resource allocator 106 and at least one User Equipment (UE) 107. The Downlink frequency Selective (DLFS) scheduling adopts a three step approach towards downlink frequency scheduling. The process may be categorized in steps of initialization and configuration of the scheduler, analyzing CQI reports of UE, and allocation of resources based on CQI of UE by the TTI processor 103.

The scheduler configuration module 101 is responsible for initialization and configuration of the scheduler. The scheduler configuration module 101 is invoked during the configuration process of the scheduler. The scheduler configuration module 101 also maintains details regarding all the cells and UEs that are in its coverage area. The cell specific initialization is performed in the initial process, wherein a threshold CQI value is configured for the allocation of resources. This threshold value defines the limits for acceptable levels of the CQI of every UE 107. Any UE 107 with sub-band CQI value less than threshold value is not allocated that sub-band during the resource allocation for that UE. The scheduler configuration module 101 will configure the maximum downlink bandwidth per UE 107 to cap off the maximum allocation per UE 107 and to avoid starvation. Further, for each TTI in the sub frames, the entire downlink bandwidth is divided into sub-bands. The scheduler configuration module 101 may also maintain the sub-bands at the sub frame level. Each sub-band may contain information about start of the sub-band, size of the sub-band, and details as to whether the sub-band is available for allocation or not. All the sub-bands may be termed as holes during the cell initialization process. The scheduler configuration module 101 also maintains details pertaining to the holes, which correspond to the sub-bands that are available for allocation. All the holes in the bandwidth may be maintained in a linked list of the holes.

The CQI handler 102 handles the sub-band and wide-band CQI reports provided by the UE 107. The CQI handler 102 is invoked per UE 107 on reception of a CQI report from the UE 107 at the base station. The CQI handler 102 processes the CQI values in three stages; CQI updation, CQI list sorting and CQI deviation computation. During CQI updation, the CQI handler 102 assumes the latest available CQI report to be the valid report until the latest report is overridden by a subsequent report. Every UE 107 may comprise of a list of valid sub-band CQI reports. During CQI sorting, the CQI handler 102 may sort the sub-band CQI list in descending order of CQI's of UEs 107. The scheduler may use this list during allocation of sub-bands to the UE's during TTI processing. In addition, the average deviation in the CQI values from the average CQI value is computed for each UE 107. The computed deviation value may be employed for re-ordering the UEs 107 for scheduling.

The UE selector 104 selects the UE 107 to which the resource is to be allocated. The UE selector 104 assigns priority to UEs 107 based on factors such as the Quality of service (QOS) requirements of the UEs 107, downlink channel conditions, total power constraints, total available downlink bandwidth and the like. The output of the module may be a list of UEs 107 selected along with their respective byte requirements, which are fed into the resource allocator 106.

The database 105 acts as a repository and stores all the details regarding the UEs 107 and the sub-band details of the UEs 107. The configuration details, initialization details of the UE 107 and the cells may be stored in the database 105. The database 105 also stores the updates received from the UE 107 for the CQI reports. In addition, the database 105 maintains the list of UEs 107 to be scheduled for transmission. When the resource allocator 106 requests for information on the UE 107 to be scheduled, the database 105 provides the list maintained by it.

The resource allocator 106 is invoked by the UE selector 104 with the list of UEs contending for allocation along with their respective byte requirements. The resource allocator 106 performs re-arrangement of UEs. During this process, the resource allocator 106 sorts the UEs in descending order of their average CQI deviation values. This ensures that the UEs with larger deviation from the average CQI get preference for allocation of better sub-bands as compared to the UEs with smaller deviation from the average CQI. The probability of the UEs having more number of good sub-bands is inversely proportional to the average CQI deviation of the sub-bands from the average CQI value.

The resource allocator 106 may allocate the resource blocks to each UE 107. The sorted list of UE 107 may be fetched in order to allocate resource blocks for UEs 107 until the bandwidth is exhausted. The allocation may be based on either sub-band or on wide-band CQIs. Wide-band CQI based allocation may be done for the UEs 107 with zero average CQI deviation and with wide-band CQI value greater than threshold CQI value. In case of wide-band CQI based allocation, the list of available holes for the sub-frame is checked and allocation is done as per wide-band CQI values. Sub-band CQI based allocation may be done for the UEs 107 with non-zero average CQI deviation. In case of sub-band CQI based allocation, the sorted sub-band CQI list (maintained per UE) and corresponding sub-band's availability is checked and allocation is done as per the corresponding sub-band CQI value. Allocation is stopped when the maximum downlink bandwidth per UE 107 is reached, or UE's bytes to be allocated are satisfied, or if UE's requirement is less than the half of the hole size. These constraints maximize the bandwidth utilization and avoid over allocation of resources per UE 107. The resource allocator 106 sends the allocated sub-bands to the UE selector 104, which forwards the allocated sub-bands to the TTI processor 103. The TTI processor 103 sends the allocated sub-bands to the UE 107. In another embodiment herein, the resource allocator 106 may send the allocated sub-bands directly to the TTI processor 103.

The TTI processor 103 is invoked at every scheduling period during TTI processing. The TTI processor 103 controls the functioning of modules such as resource allocator 106 and UE selector 104. In another embodiment herein, the resource allocator 106 and the UE selector 104 may be present within the TTI processor 103. In another embodiment herein, the resource allocator 106 may be present within the TTI processor 103. In another embodiment herein, the UE selector 104 may be present within the TTI processor 103.

The UE 107 may be any user equipment for which the frequency band is to be allocated for downlink transmission. The UE 107's context has to be initialized at the beginning of the allocation process at the network. The UE 107's context may maintain list of sub-band CQIs. The number of sub-band CQIs in the UE 107's context may be equal to the total number of downlink sub-bands per cell. The value of sub-band CQI corresponds to the CQI for the corresponding sub-band. The sub-band CQI may be maintained in descending order of the CQI values for the UE 107. The sub-band CQI maintained in the UE 107's context may contain index to the cell wide sub-band for which the CQI is maintained. Also, the CQI value along with a pointer to next CQI in the sub-band CQI list may be maintained in descending order of the CQI values.

In an embodiment, the modulation and coding schemes may be determined for the sub-band allocation of the UEs. The modulation and coding schemes are determined by referring to the weighted average CQI values of UEs.

In an embodiment, the resource allocator module 106 sends the allocation report as feedback to the UE selector module 104. The feedback contains the list of UE's scheduled, resource block allocation for each UE, satisfied number of bytes for each UE, resource allocation type and DCI format information.

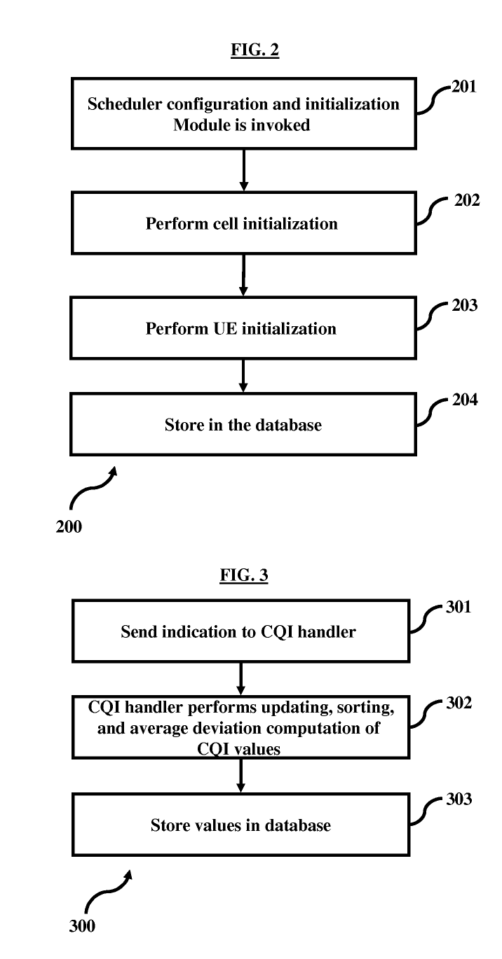

FIG. 2 is a flow chart depicting the process of DLFS initialization, according to embodiments disclosed herein. During the beginning of the scheduling process, the scheduler configuration and initialization module 101 is invoked (201). This module performs cell specific and UE specific initialization. Further, cell specific initialization is performed (202). During this process, a threshold value is configured for CQI reports obtained from UE 107. This threshold value of CQI ensures that the sub-bands that have CQI value less than the threshold value are not selected for scheduling for a UE 107. In addition, a maximum downlink bandwidth per UE 107 is defined in order to cap off the maximum allocation per UE 107 and to avoid starvation. For each TTI, the entire downlink bandwidth may be divided into sub-bands. The sub-bands may be of the same size as a RBG (Resource Block Group). In an embodiment, the total number of downlink sub-bands is given by: Total number of downlink sub-bands=(total downlink bandwidth/resource block group size corresponding to total downlink bandwidth).

In an example, consider that the total downlink bandwidth is 100 RBs and the resource block group size corresponding to the total downlink bandwidth is 4, then the Total number of downlink sub-bands=100/4=25.

If the total number of downlink sub-bands is a fractional value, then the total number of downlink sub-bands is rounded up to the higher integer. In an example, consider that the total downlink bandwidth is 25 RBs and the resource block group size corresponding to the total downlink bandwidth is 2, then the Total number of downlink sub-bands=25/2=12.5≈13.

The scheduler may also maintain details pertaining to sub-bands including but not limited to the starting frequency of sub-bands, size of sub-bands, and information on whether a sub-band is available for allocation. The scheduler may also provide details on the holes that correspond to the sub-bands that are available for allocation.

Once cell initialization is done, the UE 107 is initialized (203). During UE 107 initialization, each UE 107 may maintain a list of sub-band CQIs. In an embodiment, the number of sub-band CQIs per UE 107 may be equal to the total number of downlink sub-bands per cell. The list of sub-band CQIs may be available in descending order. In another embodiment herein, the list of sub-band CQIs may be available in descending order. Further, each sub-band CQI may index the cell-wide sub-band for which CQI is maintained. The sub-band CQI may be initialized with the value of wide-band CQI if wide-band CQI is present. In case there is no wide-band CQI, default CQI value may be assigned to the sub-band CQI. The values are stored (204) in a database 105. The various actions in method 200 may be performed in the order presented, in a different order or simultaneously. Further, in some embodiments, some actions listed in FIG. 2 may be omitted.

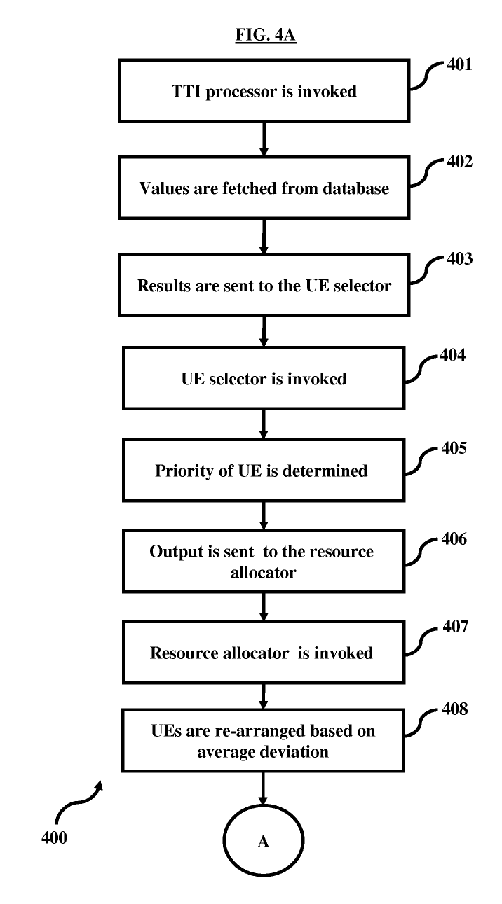

FIG. 3 is a flow chart depicting the calculation of the CQI values, according to embodiments as disclosed herein. An indication is sent (301) to the CQI handler 102 on reception of a CQI report from the UE. The CQI handler 102 handles wide-band and sub-band CQI reports sent from the UEs 107a, 107b and 107c. The CQI handler 102 is invoked on a per UE basis. The CQI handler 102 performs (302) CQI updation. During the CQI updation, the latest received CQI report is assumed to be the valid report unless overridden by a subsequent report. After updating the CQI list, the CQI list may be sorted. The scheduler may sort the CQI reports in descending order of their CQI values and maintain the list for each UE 107. The sorted list may be employed while allocation of sub-bands to the UEs 107a, 107b and 107c during TTI processing. Further, deviation of the CQI values from the average CQI is computed for each sub-band and an average deviation value is computed per UE. The computed average deviation value may be maintained for re-ordering the UEs 107a, 107b and 107c during scheduling. The computed results may be stored (303) in the database 105. The various actions in method 300 may be performed in the order presented, in a different order or simultaneously. Further, in some embodiments, some actions listed in FIG. 3 may be omitted.

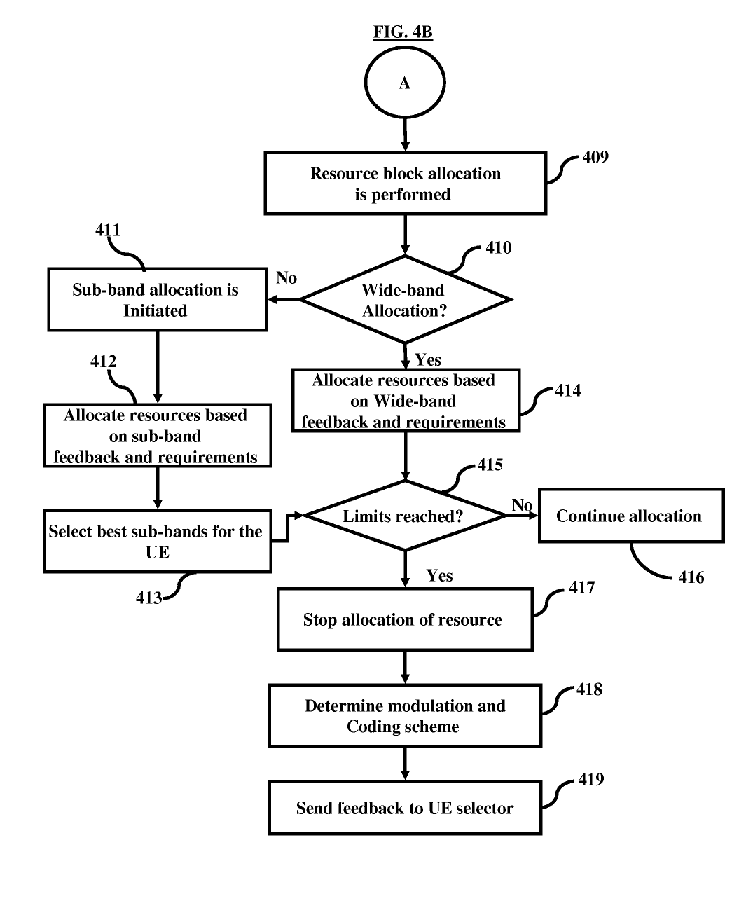

FIGS. 4A-4B are flowcharts 400 depicting the DLFS transmission process, according to embodiments as disclosed herein. The TTI processor 103 is invoked (401) during every scheduling period by a trigger. The required values are fetched (402) by the TTI processor 103 and sent (403) to the UE selector 104 for selection of the UEs 107a, 107b and 107c. On receiving the values, the UE selector 104 is invoked (404). The scheduling priority of the UE 107 is determined (405) based on factors comprising of QoS requirements of the services, downlink channel conditions, total power constraints, total available downlink bandwidth and the like. The output of this module is a list of UEs 107a, 107b and 107c selected for scheduling along with their respective byte requirements. The output is then fed (406) to a resource allocator 106, which is then invoked (407). The list of UE 107a, 107b and 107c contending for allocation along with their respective byte requirements may be provided to the resource allocator 106.

The UEs 107a, 107b and 107c may be re-arranged (408) in descending order of the computed average deviation value for the UEs 107a, 107b and 107c. The re-arrangement ensures that UEs 107a, 107b and 107c with larger deviation from the average CQI get preference for allocation of better sub-bands as compared to the UEs 107a, 107b and 107c with smaller deviation. The probability of UEs 107a, 107b and 107c having higher number of good sub-bands is inversely proportional to the CQI deviation of the sub-bands from the average CQI value. Further, resource block allocation may be performed (409). During resource block allocation the scheduler may traverse the list of sorted UEs 107a, 107b and 107c and perform the RB allocation for the UE 107a, 107b and 107c until the bandwidth exhausts. For each UE 107, the allocation is either based on wide-band CQI or sub-band CQI. A check is made (410) if the allocation is for wide-band CQI. If the allocation is for wide-band CQI, the resources may be allocated (414) based on the wide-band feedback and requirements. In this case, the scheduler may go through the list of holes for the sub-frame and allocate resources as per the wideband CQI. If the allocation is based on sub-band CQI, sub-band allocation is initiated (411) and resources are allocated (412) based on sub-band feedback and requirements. Further, the best sub-bands are selected (413) for the UE 107. The scheduler may go through the list of sub-band CQIs maintained. If the sub-band CQI is greater than the threshold CQI and the corresponding sub-band is free, the sub-bands may be allocated to the UEs 107a, 107b and 107c. Further, a check is made (415) if the limits specified are reached. The limits may be like maximum downlink bandwidth per UE 107, total bytes to be allocated for the UE 107 or if the requirements of the UE 107 is lesser than half of the hole size. In case the limits are reached, then the scheduler may stop (417) the allocation process. On the other hand, if the limit is not reached the allocation may be continued (416)

Further, the modulation and coding scheme may be determined (418) using the weighted average CQI which may be determined as follows: MCS CQI=summation of (number of RBs in scheduled sub-band m*CQI value of the scheduled sub-band)/total number of RBs scheduled to UE.

The modulation and coding scheme may be determined for each UE 107 selected. The allocation report is sent (419) as feedback by the allocator to the UE selector module 104. The details of scheduled UEs 107a, 107b and 107c, RB allocation, satisfied number of bytes, resource allocation type and DCI format information for each UE may be provided as feedback to the UE selector module 104. The various actions in method 400 may be performed in the order presented, in a different order or simultaneously. Further, in some embodiments, some actions listed in FIG. 4 may be omitted.

The method employed in the embodiments herein works with the resource allocation types supported by the LTE, which places constraints on the RBs on which the UEs can be scheduled. The overall approach of DLFS results in optimal utilization of downlink bandwidth by enabling allocation of UEs in the best possible sub-bands, and thereby, reducing the number of RBs as compared to non-DLFS systems. Reducing the number of RBs results in increased cell throughput by way of accommodating more number of UEs for a configured bandwidth. The method achieves good cell throughput with low Block Error Rate (BLER), and significantly reduced computational complexity and time.

The embodiments disclosed herein can be implemented through at least one software program running on at least one hardware device and performing network management functions to control the network elements. The network elements shown in FIG. 1 include blocks which can be at least one of a hardware device, or a combination of hardware device and software module.

The embodiment disclosed herein describes a method for efficient downlink bandwidth utilization by optimally allocating user equipments in the best sub-bands. Therefore, it is understood that the scope of the protection is extended to such a program and in addition to a computer readable means having a message therein, such computer readable storage contain program code meant for implementation of one or more steps of the method, when the program runs on a server or mobile device or any suitable programmable device. The method embodiments described herein could be implemented partly in hardware and partly in software. Alternatively, the invention may be implemented on different hardware devices, e.g. using a plurality of CPUs.

The foregoing description of the specific embodiments will so fully reveal the general nature of the embodiments herein that others can, by applying current knowledge, readily modify and/or adapt for various applications of such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

What is claimed is:

1. A system for downlink frequency division selective scheduling in a communication network, said system adapted for:
configuring transmission by:
assigning a threshold value for feedback report of sub-bands; and
assigning up to maximum downlink bandwidth per User Equipment (UE) to a plurality of UEs,
handling said feedback reports by:
checking validity of said feedback reports;
updating said feedback reports;
sorting said feedback reports in descending order of their feedback values; and
computing average deviation of said feedback reports from average value,
scheduling a plurality of UEs for transmission during Transmission Time Interval (TTI) by:
selecting plurality of UEs for resource allocation based on said feedback reports;
sorting said UEs for allocation of resource based on their computed average deviation; and
allocating resources to said UEs until certain pre-defined limits are satisfied.

2. The system as in claim 1, wherein said feedback report is Channel Quality Indicator (CQI) report.

3. The system as in claim 1, wherein said system is adapted for defining said threshold value for feedback reports such that sub-bands having feedback values below said threshold value are not selected for scheduling.

4. The system as in claim 1, wherein said system is adapted for validating said feedback report by checking if said report is the latest report received from said UEs.

5. The system as in claim 1, wherein said system is adapted for updating said feedback report by replacing an available report with the latest report received from said UEs.

6. The system as in claim 1, wherein said system is adapted for dividing said available downlink bandwidth into sub-bands of resource block group (RBG) size.

7. The system as in claim 1, wherein said system is adapted for computing deviation of said feedback reports from the average sub-band report value for each sub-band.

8. The system as in claim 1, wherein said system is adapted for computing average deviation of said feedback reports for each UE.

9. The system as in claim 1, wherein said system is adapted for sorting said UEs in descending order of computed average deviation during said TTI.

10. The system as in claim 1, wherein said limits are at least one of:
maximum downlink bandwidth per UE is satisfied;
bytes to be allocated for said UEs is exhausted;
requirement of resource blocks of said UE is less than half the size of available sub-band.

11. A Channel Quality Indicator (CQI) handler module for downlink frequency selective scheduling in a communication network, said CQI handler module adapted for performing action that includes at least one of:
updating feedback reports received from plurality of UEs;
sorting said feedback reports of said UEs based on feedback values; and
computing average deviation of said feedback reports from average report value.

12. The CQI handler module, as in claim 11, wherein said CQI handler module is adapted for managing both wide-band and sub-band feedback reports received from said UEs.

13. The CQI handler module, as in claim 11, wherein said CQI handler module is adapted for sorting said feedback reports in descending order of their values.

14. A User Equipment (UE) selector module for downlink frequency selective scheduling in a communication network, said selector module is adapted for:
determining scheduling priority of plurality of User Equipments (UE) based on certain factors; and
sending a list of UEs to a resource allocator for allocation of bandwidth.

15. The UE selector module, as in claim 14, wherein said UE selector module is adapted for scheduling priority on factors that include at least one of:
Quality of Service (QOS) requirements of the service;
downlink channel conditions;
total power constraints; and
total available downlink bandwidth.

16. A resource allocator module for downlink frequency selective scheduling in a communication network, said allocator module adapted for:
re-arranging received list of UE in descending order of their computed average deviation;
allocation of best available sub-bands until pre-defined constraints are satisfied; and
determining the modulation and coding scheme based on the feedback report values of UEs.

17. The resource allocator module as in claim 16, wherein said resource allocator module is adapted for allocation of bandwidth based on constraints that include at least one of:
maximum downlink bandwidth per UE is satisfied;
bytes to be allocated for said UEs is exhausted;
requirement of resource blocks of said UE is less than half the size of available sub-band.

18. The resource allocator module as in claim 16, wherein said resource allocator module is adapted for sending allocation report of said UEs to a UE selector module.

19. A method for downlink frequency division selective scheduling in a communication network, the method comprising steps of:
configuring transmission by:
assigning a threshold value for feedback report of sub-bands;
assigning maximum downlink bandwidth per User Equipment (UE) to a plurality of UEs;
handling said feedback reports by:
checking validity of said feedback reports;
updating said feedback reports;
sorting said feedback reports in descending order of their feedback values; and
computing average deviation of said feedback reports from defined threshold value;
scheduling a plurality of UEs for transmission during Transmission Time Interval (TTI) by:
selecting plurality of UEs for resource allocation based on said feedback reports;
sorting said UEs for allocation of resource based on their feedback reports; and
allocating resources to said UEs until pre-defined limits are satisfied.

20. The method as in claim 19, wherein said feedback report is Channel Quality Indicator (CQI) report.

21. The method as in claim 19, wherein said threshold value for feedback reports is defined such that sub-bands having feedback values below said threshold value are not selected for scheduling.

22. The method as in claim 19, wherein said validation of said report is performed by checking said report is the latest report received from UEs.

23. The method as in claim 19, wherein said updation is performed by replacing an available report with the latest report received from said UEs.

24. The method as in claim 19, wherein average deviation of said feedback reports is computed for each sub-band.

25. The method as in claim 19, wherein said method computes average deviation of said feedback reports for each UE.

26. The method as in claim 19, wherein said method sorts said UEs in descending order of computed average deviation during said TTI.

27. The method as in claim 19, wherein said method divides said available downlink bandwidth into sub-bands of size of resource block group (RBG).

28. The method as in claim 19, wherein said method determines scheduling priority of said UEs using a UE selector.

29. The method as in claim 19, wherein said method further determines the modulation and coding scheme based on the CQI values of said UEs.
